(19) United States
(12) Patent Application Publication
(10) Pub. No.: US 2016/0170770 A1
(43) Pub. Date: Jun. 16, 2016

(54) PROVIDING EARLY INSTRUCTION EXECUTION IN AN OUT-OF-ORDER (OOO) PROCESSOR, AND RELATED APPARATUSES, METHODS, AND COMPUTER-READABLE MEDIA

(71) Applicant: QUALCOMM Incorporated, San Diego, CA (US)

(72) Inventors: Harold Wade Cain, III, Raleigh, NC (US); Rami Mohammad Al Sheikh, Raleigh, NC (US)

(21) Appl. No.: 14/568,637

(22) Filed: Dec. 12, 2014

(51) Int. Cl. G06F 9/38; G06F 9/30

(52) U.S. Cl. CPC G06F 9/3867; G06F 9/30109; G06F 9/30138

(57) ABSTRACT

Providing early instruction execution in an out-of-order (OOO) processor, and related apparatuses, methods, and computer-readable media are disclosed. In one aspect, an apparatus comprises an early execution engine communicatively coupled to a front-end instruction pipeline and a back-end instruction pipeline of an OOO processor. The early execution engine is configured to receive an incoming instruction from the front-end instruction pipeline, and determine whether an input operand of one or more input operands of the incoming instruction is present in a corresponding entry of one or more entries in an early register cache. The early execution engine is also configured to, responsive to determining that the input operand is present in the corresponding entry, substitute the input operand with a non-speculative immediate value stored in the corresponding entry. In some aspects, the early execution engine may execute the incoming instruction using an early execution unit and update the early register cache.

### BACKGROUND

I. Field of the Disclosure

The technology of the disclosure relates generally to execution of instructions by an out-of-order (OOO) processor.

II. Background

Out-of-order (OOO) processors are computer processors that are capable of executing computer program instructions in an order determined by an availability of each instruction's input operands, regardless of the order of appearance of the instructions in the computer program. By executing instructions out-of-order, an OOO processor may be able to fully utilize processor clock cycles that otherwise would go wasted while the OOO processor waits for data access operations to complete. For example, instead of having to “stall” (i.e., intentionally introduce a processing delay) while input data is retrieved for an older program instruction, the OOO processor may proceed with executing a more recently fetched instruction that is able to execute immediately. In this manner, processor clock cycles may be more productively utilized by the OOO processor, resulting in an increase in the number of instructions that the OOO processor is capable of processing per processor clock cycle.

However, the extent to which the number of instructions processed per clock cycle is increased may be limited by the existence of dependencies between instructions. For instance, consider the following instruction sequence:

I₁: MOV R₁, 0x0000; Load the value 0x0000 into register R₁.

I₂: MOVT R₁, 0x1000; Load the value 0x10000000 into register R₁.

I₃: R₃=R₁+R₁; Add the value of R₁ to itself and store in register R₃.

I₄: R₄=memory [R₃]; Store value at memory address R₃ in register R₄.

In the instruction sequence above, a dependency exists between instruction I₃ and instructions I₁, and between instruction I₃ and I₂ due to the fact that instruction I₃ receives a value from register R₁ as an input operand. Consequently, instruction I₃ cannot execute until both instructions I₁ and I₂ have completed. Similarly, instruction I₄ cannot execute until after a value of register R₃ has been computed by instruction I₃.

Some conventional computer microarchitectures attempt to address the issue of instruction dependencies by providing dedicated structures for caching particular register values without waiting for an instruction producing the register values to execute. One such structure is a constant cache, which may maintain a set of registers that have been recently loaded with immediate values. Similarly, other microarchitectures may provide structures such as the Intel stack engine, which may enable early execution of specific registers (e.g., for stack pointer updates). However, in both of these examples, the cached register values are restricted to register update values produced by a very limited set of instructions.

### SUMMARY OF THE DISCLOSURE

Aspects disclosed in the detailed description include providing early instruction execution in an out-of-order (OOO) processor. Related apparatuses, methods, and computer-readable media are also disclosed. In this regard, in one aspect, an apparatus comprising an early execution engine is provided. The early execution engine includes an early register cache, which in some aspects is a dedicated structure for caching non-speculative immediate values stored in registers. In some aspects, the early execution engine also includes an early execution unit that may be used to perform early execution of instructions. The early execution engine receives an incoming instruction from a front-end instruction pipeline of the OOO processor, and determines whether an input operand of the incoming instruction is present in an entry in the early register cache. If so, the early execution engine substitutes the input operand of the incoming instruction with a non-speculative immediate value cached in an entry of the early register cache. In this manner, input operands may be replaced with cached immediate values, thus allowing the incoming instruction to be executed without requiring a register access. In some aspects, the early execution engine may further determine whether the incoming instruction is an early-execution-eligible instruction (e.g., a relatively simple arithmetic, logic, or shift operation supported by the early execution unit). If the incoming instruction is an early-execution-eligible instruction, the early execution engine may execute the incoming instruction using the early execution unit. The early execution engine may then write an output value resulting from the early execution of the incoming instruction to the early register cache. In some aspects, the incoming instruction may then be replaced by an outgoing instruction which is provided to a back-end instruction pipeline of the OOO processor.

In another aspect, an apparatus comprising an early execution engine is provided. The early execution engine is communicatively coupled to a front-end instruction pipeline and a back-end instruction pipeline of an OOO processor. The early execution engine comprises an early execution unit and an early register cache. The early execution engine is configured to receive an incoming instruction from the front-end instruction pipeline. The early execution engine is further configured to determine whether an input operand of one or more input operands of the incoming instruction is present in a corresponding entry of one or more entries in the early register cache. The early execution engine is also configured to, responsive to determining that the input operand is present in the corresponding entry, substitute the input operand with a non-speculative immediate value stored in the corresponding entry.

In another aspect, an apparatus comprising an early execution engine of an OOO processor is provided. The early execution engine comprises a means for receiving an incoming instruction from a front-end instruction pipeline of the OOO processor. The early execution engine further comprises a means for determining whether an input operand of one or more input operands of the incoming instruction is present in a corresponding entry of one or more entries in an early register cache of the early execution engine. The early execution engine also comprises a means for substituting the input operand with a non-speculative immediate value stored in the corresponding entry, responsive to determining that the input operand is present in the corresponding entry.

In another aspect, a method for providing early instruction execution is provided. The method comprises receiving, by an early execution engine of an OOO processor, an incoming instruction from a front-end instruction pipeline of the OOO processor. The method further comprises determining whether an input operand of one or more input operands of the incoming instruction is present in a corresponding entry of one or more entries in an early register cache of the early execution engine. The method also comprises, responsive to determining that the input operand is present in the corresponding entry, substituting the input operand with a non-speculative immediate value stored in the corresponding entry.

In another aspect, a non-transitory computer-readable medium is provided, having stored thereon computer-executable instructions. When executed by a processor, the computer-executable instructions cause the processor to receive an incoming instruction from a front-end instruction pipeline of the processor. The computer-executable instructions further cause the processor to determine whether an input operand of one or more input operands of the incoming instruction is present in a corresponding entry of one or more entries in an early register cache of an early execution engine. The computer-executable instructions also cause the processor to substitute the input operand with a non-speculative immediate value stored in the corresponding entry, responsive to determining that the input operand is present in the corresponding entry.

### BRIEF DESCRIPTION OF THE FIGURES

FIG. 1 is a block diagram of an exemplary out-of-order (OOO) processor including an early execution engine for providing early instruction execution;

FIG. 2 is a block diagram illustrating contents of an exemplary early register cache of the early execution engine of FIG. 1;

FIGS. 3A-3C are diagrams illustrating exemplary communications flows for the early execution engine of FIG. 1 for detecting and replacing input operands and providing early execution of an incoming early-execution-eligible instruction;

FIGS. 4A-4C are diagrams illustrating exemplary communications flows for the early execution engine of FIG. 1 for detecting and replacing input operands for an incoming instruction for which early execution is not supported, and for receiving updates to an early register cache;

FIGS. 5A-5C are diagrams illustrating exemplary communications flows for the early execution engine of FIG. 1 for detecting and handling an incoming instruction for which operands are not available, and for receiving updates to an early register cache;

FIG. 6 is a diagram illustrating exemplary communications flows for the early execution engine of FIG. 1 for detecting and recovering from a pipeline flush;

FIGS. 7A-7B are flowcharts illustrating an exemplary process for providing early instruction execution by the early execution engine of FIG. 1;

FIG. 8 is a flowchart illustrating additional exemplary operations for updating an early register cache based on received architectural register values;

FIG. 9 is a flowchart illustrating additional exemplary operations for detecting and recovering from a pipeline flush; and

FIG. 10 is a block diagram of an exemplary processor-based system that can include the early execution engine of FIG. 1.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include providing early instruction execution in an out-of-order (OOO) processor. Related apparatuses, methods, and computer-readable media are also disclosed. In this regard, in one aspect, an apparatus comprising an early execution engine is provided. The early execution engine includes an early register cache, which in some aspects is a dedicated structure for caching non-speculative immediate values stored in registers. In some aspects, the early execution engine also includes an early execution unit that may be used to perform early execution of instructions. The early execution engine receives an incoming instruction from a front-end instruction pipeline of the OOO processor, and determines whether an input operand of the incoming instruction is present in an entry in the early register cache. If so, the early execution engine substitutes the input operand of the incoming instruction with a non-speculative immediate value cached in an entry of the early register cache. In this manner, input operands may be replaced with cached immediate values, thus allowing the incoming instruction to be executed without requiring a register access. In some aspects, the early execution engine may further determine whether the incoming instruction is an early-execution-eligible instruction (e.g., a relatively simple arithmetic, logic, or shift operation supported by the early execution unit). If the incoming instruction is an early-execution-eligible instruction, the early execution engine may execute the incoming instruction using the early execution unit. The early execution engine may then write an output value resulting from the early execution of the incoming instruction to the early register cache. In some aspects, the incoming instruction may then be replaced by an outgoing instruction which is provided to a back-end instruction pipeline of the OOO processor.

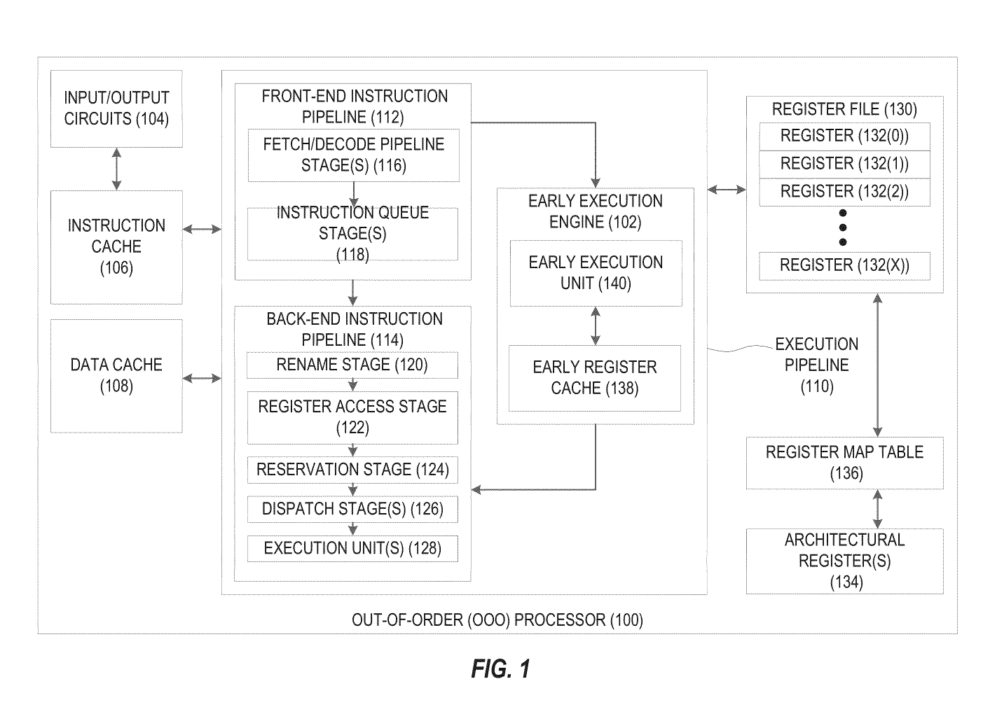

In this regard, FIG. 1 is a block diagram of an exemplary OOO processor 100 including an early execution engine 102 providing early instruction execution, as disclosed herein. The OOO processor 100 includes input/output circuits 104, an instruction cache 106, and a data cache 108. The OOO processor 100 may encompass any one of known digital logic elements, semiconductor circuits, processing cores, and/or memory structures, among other elements, or combinations thereof. Aspects described herein are not restricted to any particular arrangement of elements, and the disclosed techniques may be easily extended to various structures and layouts on semiconductor dies or packages.

The OOO processor 100 further comprises an execution pipeline 110, which may be subdivided into a front-end instruction pipeline 112 and a back-end instruction pipeline 114. As used herein, “front-end instruction pipeline 112” may refer to pipeline stages that are conventionally located at the “beginning” of the execution pipeline 110, and that provide fetching, decoding, and/or instruction queuing functionality. In this regard, the front-end instruction pipeline 112 of FIG. 1 includes one or more fetch/decode pipeline stages 116 and one or more instruction queue stages 118. As non-limiting examples, the one or more fetch/decode pipeline stages 116 may include F1, F2, and/or F3 fetch/decode stages (not shown). “Back-end instruction pipeline 114” refers herein to subsequent pipeline stages of the execution pipeline 110 for issuing instructions for execution, for carrying out the actual execution of instructions, and/or for loading and/or storing data required by or produced by instruction execution. In the example of FIG. 1, the back-end instruction pipeline 114 comprises a rename stage 120, a register access stage 122, a reservation stage 124, one or more dispatch stages 126, and one or more execution units 128. It is to be understood that the stages 116, 118 of the front-end instruction pipeline 112 and the stages 120, 122, 124, 126, 128 of the back-end instruction pipeline 114 shown in FIG. 1 are provided for illustrative purposes only, and that other aspects of the OOO processor 100 may contain additional or fewer pipeline stages than illustrated herein.

The OOO processor 100 additionally includes a register file 130, which provides physical storage for a plurality of registers 132(0)-132(X). In some aspects, the registers 132(0)-132(X) may comprise one or more general purpose registers (GPRs), a program counter (not shown), and/or a link register (not shown). During execution of computer programs by the OOO processor 100, the registers 132(0)-132(X) may be mapped to one or more architectural registers 134 using a register map table 136.

In exemplary operation, the front-end instruction pipeline 112 of the execution pipeline 110 fetches instructions (not shown) from the instruction cache 106, which in some aspects may be an on-chip Level 1 (L1) cache, as a non-limiting example. Instructions may be further decoded by the one or more fetch/decode pipeline stages 116 of the front-end instruction pipeline 112 and passed to the one or more instruction queue stages 118 pending issuance to the back-end instruction pipeline 114. After the instructions are issued to the back-end instruction pipeline 114, the stages of the back-end instruction pipeline 114 (e.g., the execution unit(s) 128)) then execute the issued instructions, and retire the executed instructions.

As discussed above, the OOO processor 100 may provide OOO processing of instructions to increase instruction processing parallelism. However, as noted above, OOO processing performance may be negatively affected by the existence of dependencies between instructions. For example, processing of an instruction that takes as input a value generated by a preceding instruction may be delayed by the OOO processor 100 until the preceding instruction has completed and the input value has been generated.

In this regard, the OOO processor 100 includes the early execution engine 102 to provide early instruction execution. While the early execution engine 102 is illustrated as an element separate from the front-end instruction pipeline 112 and the back-end instruction pipeline 114 for the sake of clarity, it is to be understood that the early execution engine 102 may be integrated into one or more of the stages 116, 118 of the front-end instruction pipeline 112. The early execution engine 102 comprises an early register cache 138, which contains one or more entries (not shown) for caching immediate values generated and stored in the architectural register(s) 134 corresponding to the registers 132(0)-132(X). The early execution engine 102 may also comprise an early execution unit 140, which may enable instructions to be executed before reaching the back-end instruction pipeline 114. The early execution unit 140 may comprise, as a non-limiting example, one or more arithmetic logic units (ALUs) or floating point units (not shown). In this manner, dependencies between instructions may be resolved at a much earlier stage within the execution pipeline 110, resulting in improved OOO processing performance.

In exemplary operation, the early execution engine 102 receives an incoming instruction (not shown) from the front-end instruction pipeline 112, and examines input operands (not shown) of the incoming instruction to determine whether an input operand of the instruction is stored in an entry of the early register cache 138. If a valid entry corresponding to the input operand is found in the early register cache 138, the early execution engine 102 substitutes the input operand of the incoming instruction with a cached non-speculative immediate value from the corresponding entry. As a result, the incoming instruction as modified by the early execution engine 102 may include immediate values as input, rather than requiring one or more register access operations to retrieve input values.

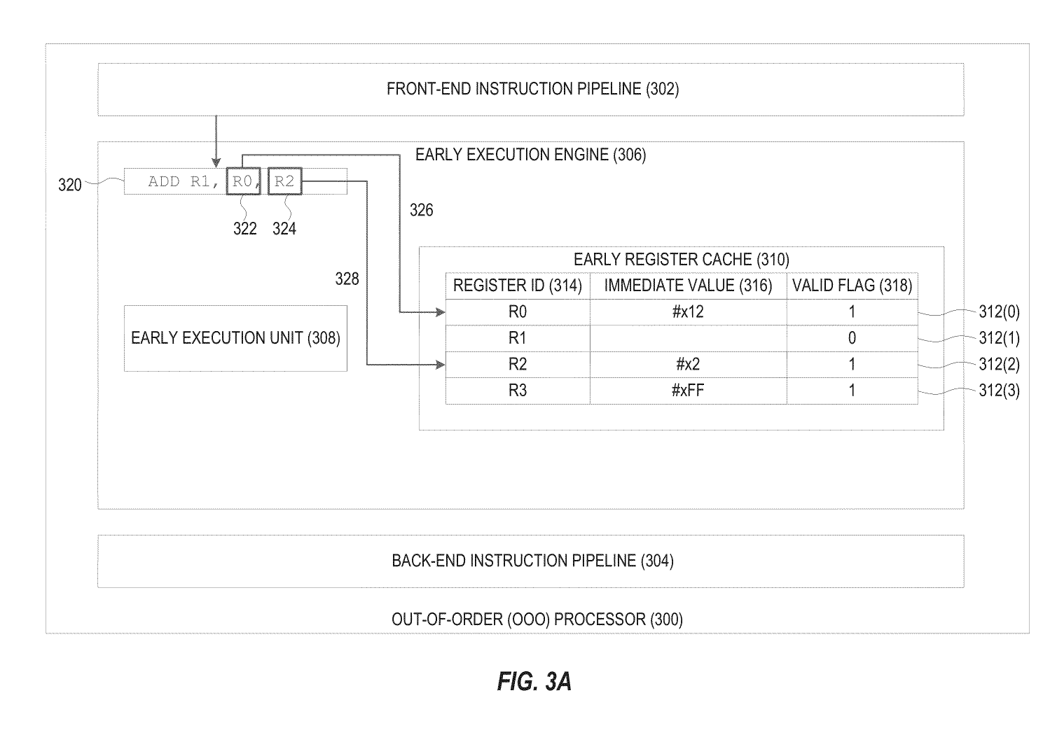

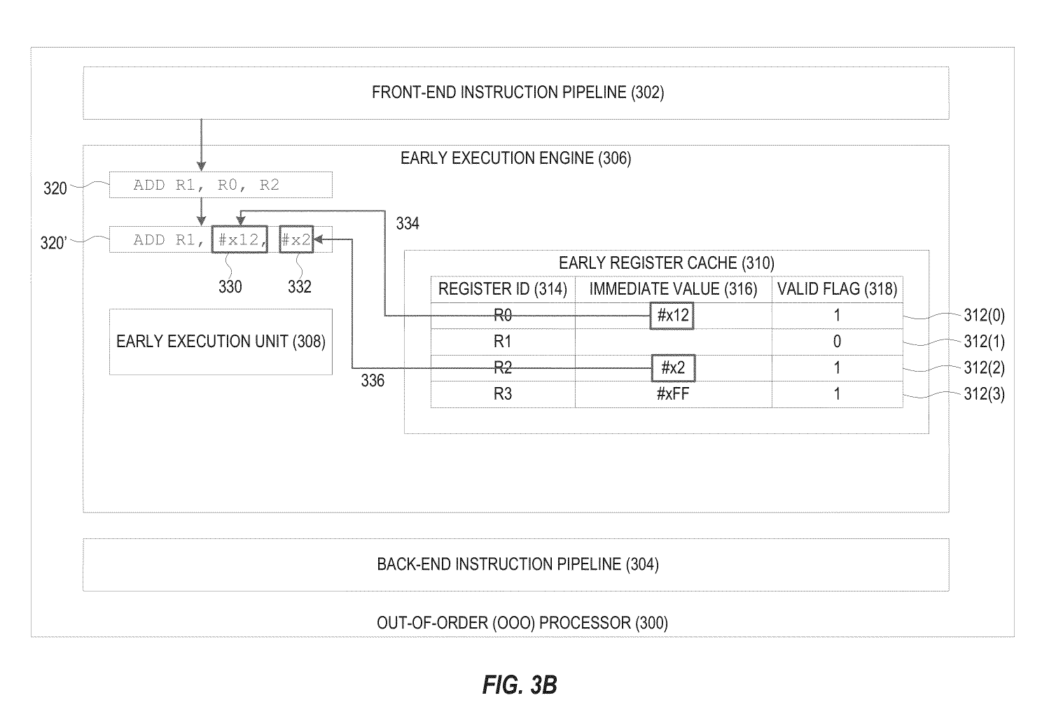

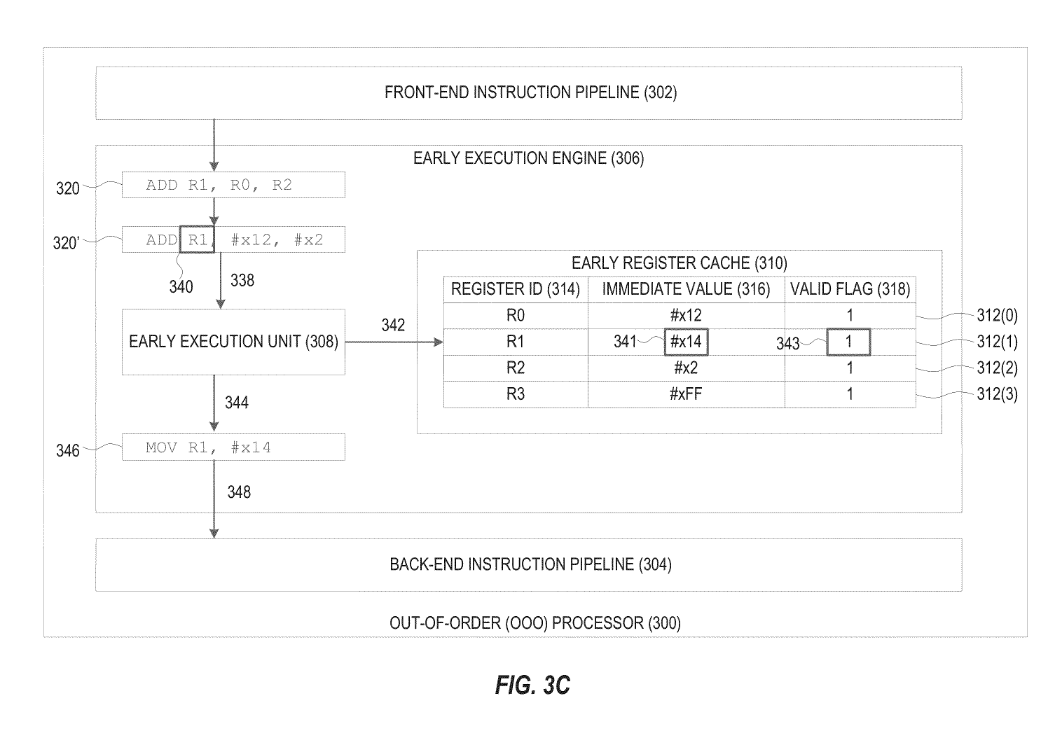

In some aspects of the early execution engine 102, a subset of instructions may be designated as eligible for early execution (i.e., execution prior to reaching the back-end instruction pipeline 114 of the execution pipeline 110). For instance, instructions having a relatively lower level of complexity, such as arithmetic, logic, or shift operations, may be designated as early-execution-eligible instructions. Early-execution-eligible instructions may be executed by the early execution unit 140 of the early execution engine 102, with output values (if any) from the early execution unit 140 written to the early register cache 138. Operations of exemplary aspects of the early execution engine 102 in processing early-execution-eligible instructions are discussed in greater detail below with respect to FIGS. 3A-3C.

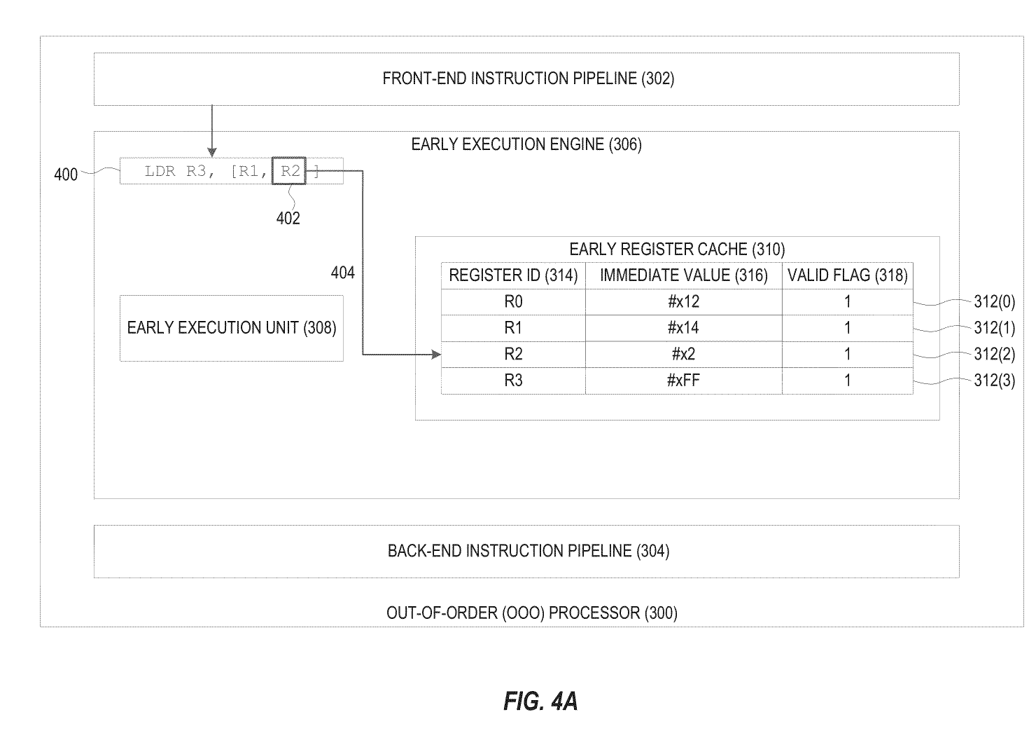

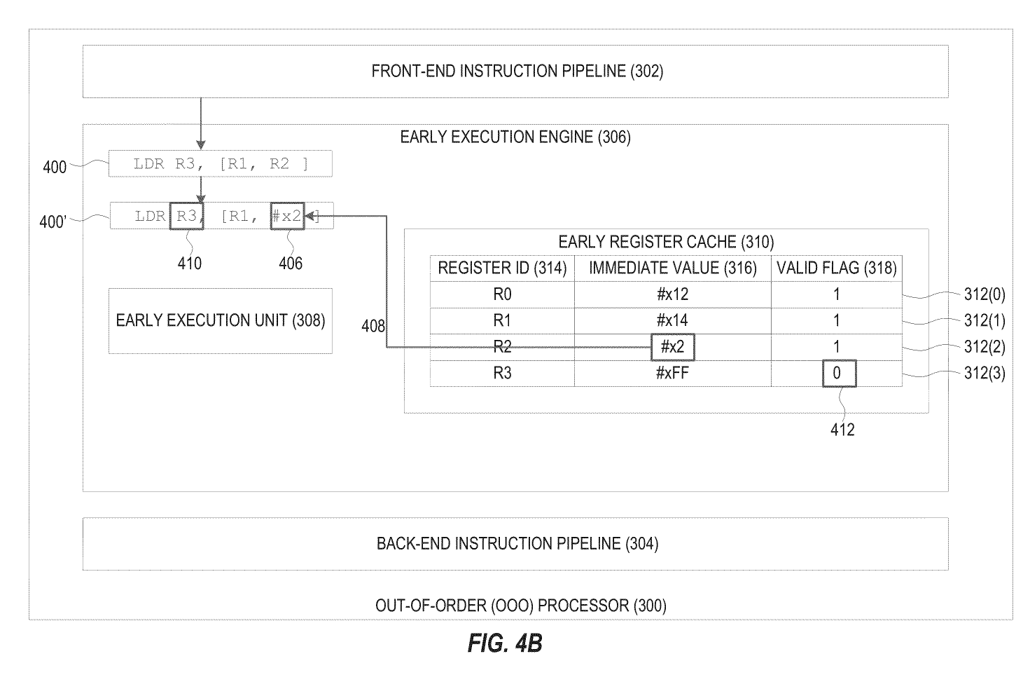

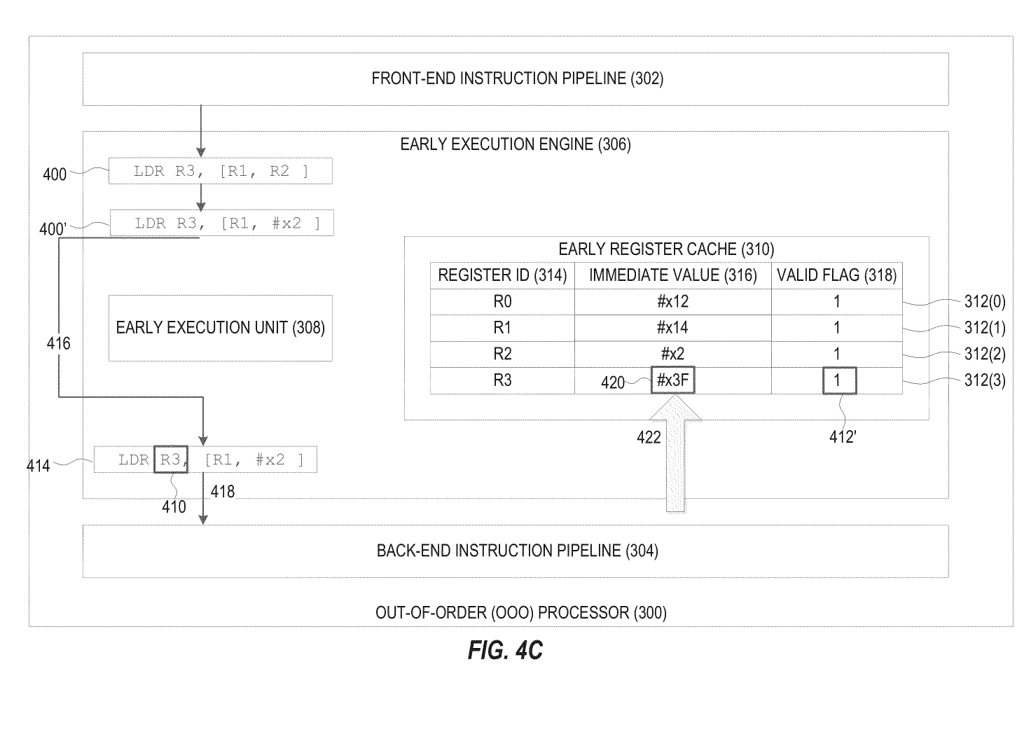

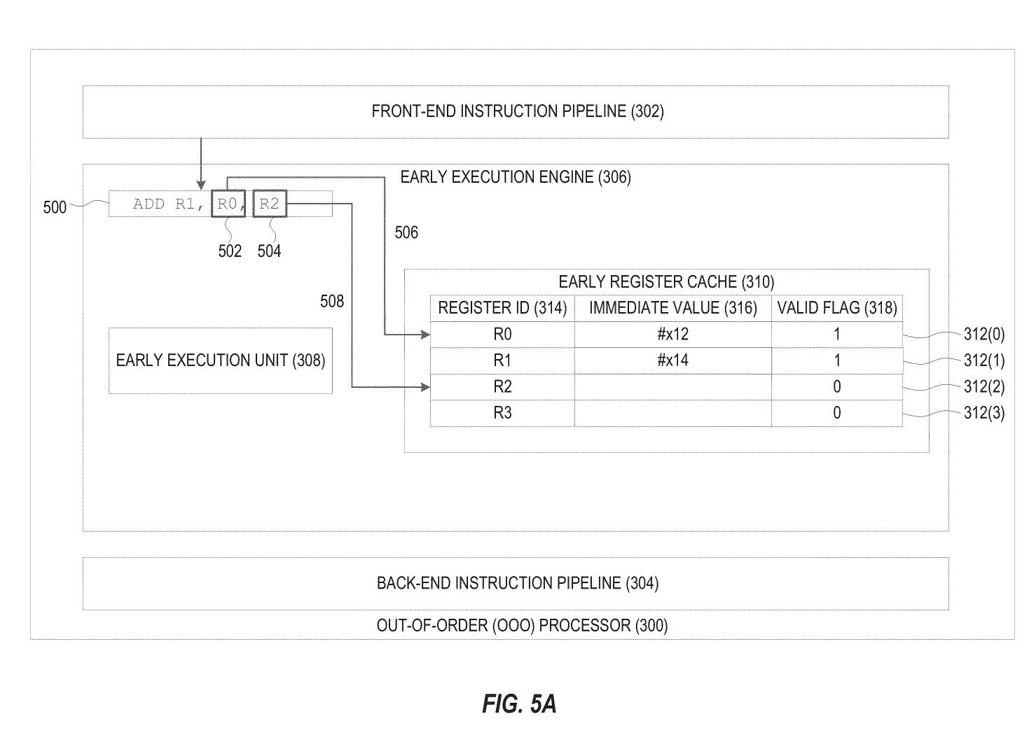

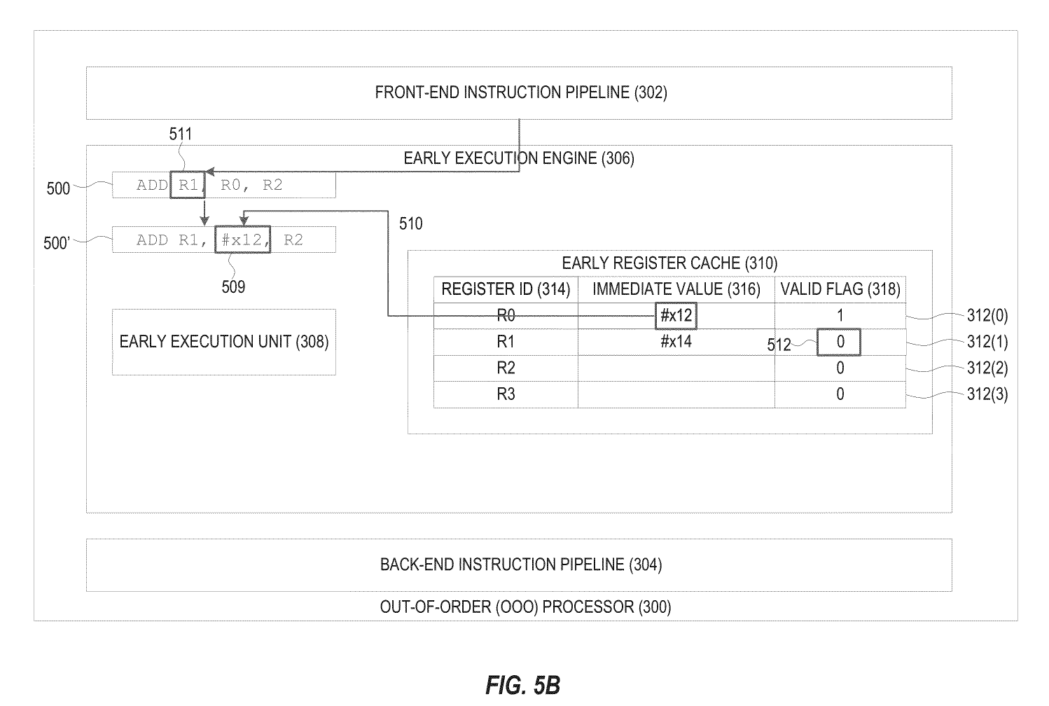

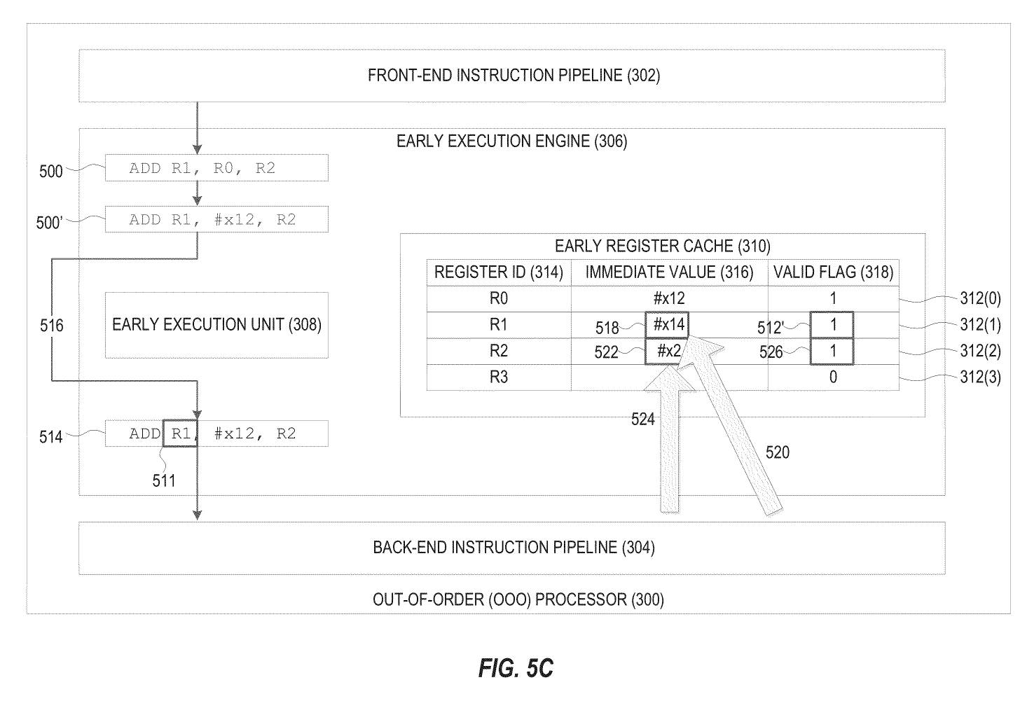

If an incoming instruction observed by the early execution engine 102 cannot be processed (i.e., because the early register cache 138 does not contain cached immediate values for all input operands of the instruction, or because the instruction is not designated as an early-execution-eligible instruction), the early execution engine 102 will mark any entries corresponding to output operands for the incoming instruction as invalid in the early register cache 138. The incoming instruction is then passed to the back-end instruction pipeline 114 for conventional processing. The early execution engine 102 may subsequently receive an output value and/or any retrieved input values for the incoming instruction from the OOO processor 100, and may update the early register cache 138 with the received values. Operations of exemplary aspects of the early execution engine 102 for handling instructions that cannot be processed by the early execution unit 140 are discussed in greater detail below with respect to FIGS. 4A-4C and 5A-5C.

It is to be understood that, in some aspects, early-execution-eligible instructions may include branch instructions that may be executed in the early execution engine 102. Early execution of branch instructions by the early execution engine 102 may result in improvements to processor performance and power consumption. Early execution of branch instructions may also result in a reduction of a perceived depth of the execution pipeline 110, and may speed up branch predictor training.

Some aspects of the early execution engine 102 may further improve performance by supporting only narrow-width operands (i.e., input and/or output operands having a size smaller than a largest size supported by the OOO processor 100). In such aspects, the early register cache 138 of the early execution engine 102 may be configured to store only the lower-order bits of each immediate value cached therein. Additionally, the early execution unit 140 may be configured to operate only on narrow-width operands.

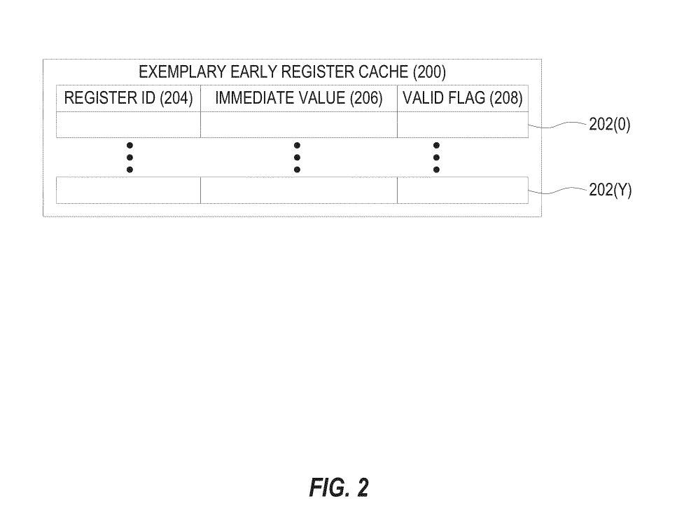

To illustrate an exemplary early register cache 200 that may correspond to the early register cache 138 of FIG. 1 in some aspects, FIG. 2 is provided. Elements of FIG. 1 are referenced for the sake of clarity in describing FIG. 2. As seen in FIG. 2, the early register cache 200 includes multiple entries 202(0)-202(Y), each associated with one of the one or more architectural registers 134 corresponding to one of the registers 132(0)-132(X) of FIG. 1. Each entry 202(0)-202(Y) includes a register identification (ID) field 204, which represents an identifier for one of the one or more architectural registers 134 corresponding to one of the entries 202(0)-202(Y). In some aspects, the register ID field 204 may store an index number of the associated architectural register 134, while some aspects may provide that the register ID field 204 stores an address of the associated architectural register 134. According to some aspects, the register ID field 204 may be dynamically assigned and/or modified by the OOO processor 100 during execution of a computer program.

Each of the entries 202(0)-202(Y) also includes an immediate value field 206. The immediate value field 206 may cache a non-speculative immediate value that has been previously generated (e.g., by execution of an instruction by the early execution unit 140 and/or the one or more execution units 128 of FIG. 1) for storage in the architectural register 134 corresponding to the entry 202(0)-202(Y). Upon subsequent detection of an incoming instruction having an input operand corresponding to the entry 202(0)-202(Y), the early execution engine 102 may substitute the input operand with contents of the immediate value field 206. In some aspects, the immediate value field 206 may store only “narrow” immediate values (i e, immediate values having a size smaller than a largest size of an immediate value supported by the OOO processor 100). As a non-limiting example, the OOO processor 100 may support 32-bit immediate values, while the immediate value field 206 may store only the lower 16 bits of a cached immediate value. Some aspects may provide that the immediate value field 206 of the early register cache 200 may store either a narrow immediate value or a “wide” (i.e., full-size) immediate value.

Each of the entries 202(0)-202(Y) of the early register cache 200 also includes a valid flag field 208 indicative of a validity of the entry 202(0)-202(Y). In some aspects, the early execution engine 102 may set the valid flag field 208 of one of the entries 202(0)-202(Y) upon updating the entry 202(0)-202(Y). The early execution engine 102 may clear the valid flag field 208 of one or more of the entries 202(0)-202(Y) to indicate that the entry 202(0)-202(Y) has been invalidated (e.g., as a result of a pipeline flush or an unsupported instruction).

It is to be understood that some aspects may provide that the entries 202(0)-202(Y) of the early register cache 200 may include other fields in addition to the fields 204, 206, and 208 illustrated in FIG. 2. It is to be further understood that the early register cache 200 in some aspects may be implemented as a cache configured according to associativity and replacement policies known in the art. In the example of FIG. 2, the early register cache 200 is illustrated as a single data structure. However, in some aspects, the early register cache 200 may also comprise more than one data structure or cache.

Some aspects of the early execution engine 102 may employ a variety of mechanisms for selectively caching immediate values to reduce bandwidth into the early register cache 200 and/or to avoid caching and updating rarely used registers. For instance, some aspects of the early execution engine 102 may be configured to cache only a subset of the one or more architectural registers 134 of FIG. 1 in the early register cache 200. As non-limiting examples, the early execution engine 102 may cache only a stack pointer, and/or only registers used for passing procedure call parameters. In such aspects, the selection of registers whose immediate values may be cached may be hardwired into the early execution engine 102, may be programmable by software, and/or may be dynamically determined by hardware.

According to some aspects disclosed herein, the early execution engine 102 may be configured to determine whether to cache immediate values based on an incoming instruction. For example, the early execution engine 102 may only cache the input or output operands of certain common opcodes, and/or may only cache input or output operands of a particular dynamic instruction (not shown) based on an observed history of the instruction. Some aspects may provide that the early execution engine 102 is configured to cache loop induction variables (not shown). In some aspects, the early execution engine 102 may be configured to cache registers that feed the computation of critical instructions (e.g., branch instructions that mispredict often, or load instructions that often result in cache misses).

FIGS. 3A-3C illustrate exemplary communications flows for the early execution engine 102 of FIG. 1 for detecting and replacing input operands and providing early execution of an early-execution-eligible incoming instruction. In FIGS. 3A-3C, an OOO processor 300, which may correspond to an exemplary aspect of the OOO processor 100 of FIG. 1, is provided. The OOO processor 300 includes a front-end instruction pipeline 302 and a back-end instruction pipeline 304, each of which may represent an aspect of the front-end instruction pipeline 112 and the back-end instruction pipeline 114, respectively, of FIG. 1. The OOO processor 300 also provides an early execution engine 306, which may correspond to an aspect of the early execution engine 102 of FIG. 1. The early execution engine 306 comprises an early execution unit 308 and an early register cache 310. The early register cache 310 includes entries 312(0)-312(3) representing architectural registers R0-R3 of the one or more architectural registers 134 of FIG. 1. Each of the entries 312(0)-312(3) includes a register ID field 314, an immediate value field 316, and a valid flag field 318, as described above with respect to FIG. 2. In the example of FIG. 3, the early register cache 310 stores three valid entries: entry 312(0), which has an immediate value of #x12 cached for register R0; entry 312(2), which has an immediate value of #x2 cached for register R2; and entry 312(3), which has an immediate value of #xFF cached for register R3.

In FIG. 3A, the early execution engine 306 receives an incoming instruction 320. The incoming instruction 320 in this example is an ADD instruction intended to sum the values of input operands 322 and 324 (corresponding to registers R0 and R2, respectively), and store the result in register R1. For purposes of illustration, it is to be assumed that the ADD instruction falls within a subset of instructions that have been designated as early-execution-eligible by the OOO processor 300.

Upon receiving the incoming instruction 320, the early execution engine 306 determines whether either of input operands 322, 324 is present in a corresponding entry 312(0)-312(3) of the early register cache 310. As indicated by arrows 326 and 328, the early execution engine 306 in FIG. 3A successfully locates valid entries 312(0) and 312(2) corresponding to the input operands 322, 324. As a result, the early execution engine 306 is able to replace the input operands 322, 324 with the cached immediate values stored in the entries 312(0) and 312(2).

Referring now to FIG. 3B, the early execution engine 306 substitutes the input operands 322 and 324 of FIG. 3A with non-speculative immediate values 330 and 332, respectively, stored in the immediate value field 316 of the entries 312(0) and 312(2), as indicated by arrows 334 and 336. A resulting incoming instruction 320′ may now be executed without accessing the registers R0 and R2 to obtain input values. In this manner, performance of the OOO processor 300 may be improved by eliminating instruction dependencies within the early execution engine 306.

In some aspects, performance of the OOO processor 300 may be further improved through early execution of instructions by the early execution engine 306. In this regard, in FIG. 3C, the early execution engine 306 evaluates the incoming instruction 320′ to determine whether it is an early-execution-eligible instruction. In the example of FIG. 3C, the incoming instruction 320′ is determined to be an early-execution-eligible instruction 320′, and is passed to the early execution unit 308 for execution, as indicated by arrow 338. After execution of the early-execution-eligible instruction 320′ is complete, the early execution unit 308 then updates the entry 312(1) of the early register cache 310 corresponding to an output operand 340 with an output value 341, as indicated by arrow 342. The valid flag field 318 of the entry 312(1) is also updated to a value 343 of one (1) to indicate that the entry 312(1) is valid.

According to some aspects, upon successful execution of the early-execution-eligible instruction 320′, the early execution engine 306 may replace the early-execution-eligible instruction 320′ with an outgoing instruction that reproduces a result of execution of the early-execution-eligible instruction 320′ in the back-end instruction pipeline 304. In the example of FIG. 3C, if the early-execution-eligible instruction 320′ had been executed by the back-end instruction pipeline 304, the result would have been the value #x14 stored in architectural register R1. Accordingly, as indicated by arrow 344, the early execution engine 306 may replace the early-execution-eligible instruction 320′ with an outgoing instruction 346, which in this example is a MOV instruction that loads an immediate value of #x14 into register R1. The outgoing instruction 346 is then provided to the back-end instruction pipeline 304 for execution, as indicated by arrow 348.

FIGS. 4A-4C are diagrams illustrating exemplary communications flows for the early execution engine 306 of FIGS. 3A-3C for detecting and replacing input operands for an incoming instruction for which early execution is not supported, and for receiving updates to the early register cache 310. Elements of FIGS. 3A-3C are referenced in describing FIGS. 4A-4C for the sake of clarity. As seen in FIG. 4A, the early execution engine 306 receives an incoming instruction 400. In this example, the incoming instruction 400 is an LDR instruction for accessing a memory location indicated by the value of register R1 and an immediate value offset stored in register R2, indicated by input operand 402. The LDR instruction then stores the result of the memory access in register R3. For purposes of illustration, it is assumed that the LDR instruction, which may involve a relative complex memory access operation, is not eligible for early execution by the early execution engine 306.

The early execution engine 306 first consults the early register cache 310 to determine whether the input operand 402 is present in one of the entries 312(0)-312(3) of the early register cache 310, as indicated by arrow 404. In this example, the input operand 402 corresponds to the entry 312(2). Accordingly, as seen in FIG. 4B, the early execution engine 306 substitutes the input operand 402 of FIG. 4A with a non-speculative immediate value 406 stored in the immediate value field 316 of the entry 312(2), resulting in an incoming instruction 400′, as indicated by arrow 408.

The early execution engine 306 then determines whether the incoming instruction 400′ in FIG. 4B is an early-execution-eligible instruction. Upon determining that the LDR operation of the incoming instruction 400′ is not eligible for early execution, the early execution engine 306 invalidates the entry 312(3) of the early register cache 310 corresponding to an output operand 410 of the incoming instruction 400′. In the example of FIG. 4B, this is accomplished by setting the valid flag field 318 of the entry 312(3) to a value 412 of zero (0).

Referring now to FIG. 4C, the early execution engine 306 provides the incoming instruction 400′ to the back-end instruction pipeline 304 as an outgoing instruction 414 for execution, as indicated by arrows 416 and 418. In some aspects, the outgoing instruction 414 provided to the back-end instruction pipeline 304 may be marked by the OOO processor 300 to indicate that its output is to be written back to the early register cache 310 of the early execution engine 306. Some aspects may provide that only outgoing instructions 414 having output operands 410 corresponding to an entry 312(0)-312(3) of the early register cache 310 are marked by the OOO processor 300.

In the example of FIG. 4C, after the outgoing instruction 414 is executed by the back-end instruction pipeline 304, the early execution engine 306 receives a resulting immediate value 420 via a feedback path 422 from the OOO processor 300. The immediate value 420 is stored in the entry 312(3) corresponding to the output operand 410 (i.e., register R3), and the valid flag field 318 of the entry 312(3) is set to a value 412′ of one (1), indicating that the entry 312(3) is now valid. Some aspects may provide that the early execution engine 306 may receive the immediate value 420 via conventional recovery mechanisms of the OOO processor 300 to copy contents from the register file 130 of FIG. 1 into the early register cache 310.

FIGS. 5A-5C are diagrams illustrating exemplary communications flows for the early execution engine 306 of FIGS. 3A-3C and 4A-4C for detecting and handling an incoming instruction for which operands are not available, and for receiving updates to the early register cache 310. Elements of FIGS. 3A-3C are referenced in describing FIGS. 5A-5C for the sake of clarity. In the example of FIG. 5A, the early register cache 310 includes only two valid entries: entry 312(0), which has an immediate value of #x12 cached for register R0; and entry 312(1), which has an immediate value of #x14 cached for register R1.

In FIG. 5A, the early execution engine 306 receives an incoming instruction 500. Like the incoming instruction 320 of FIG. 3A, the incoming instruction 500 is an ADD instruction that sums the values of input operands 502 and 504 (corresponding to registers R0 and R2, respectively), and stores the result in register R1. Upon receiving the incoming instruction 500, the early execution engine 306 determines whether either of input operands 502, 504 is present in a corresponding entry 312(0)-312(3) of the early register cache 310. As indicated by arrow 506, the early execution engine 306 in FIG. 5A successfully locates a valid entry 312(0) corresponding to the input operand 502 in the early register cache 310. As a result, the early execution engine 306 is able to replace the input operand 502 with the cached immediate value stored in the entry 312(0). However, the entry 312(2) in the early register cache 310 corresponding to the input operand 504 is found to be invalid, as indicated by arrow 508.

Turning now to FIG. 5B, the early execution engine 306 substitutes the input operand 502 of FIG. 5A with a non-speculative immediate value 509 stored in the immediate value field 316 of the entry 312(0), as indicated by arrow 510. Accordingly, when a resulting incoming instruction 500′ is executed, the register R0 will not need to be accessed to obtain an input value. However, because the input operand 504 of FIG. 5A does not correspond to a valid entry 312(0)-312(3) in the early register cache 310, the incoming instruction 500 is not eligible to be processed by the early execution engine 306. Consequently and as shown in FIG. 5B, the early execution engine 306 invalidates the entry 312(1) of the early register cache 310 corresponding to an output operand 511 (i.e., register R1) of the incoming instruction 500. As seen in FIG. 5B, this is accomplished in this example by setting the valid flag field 318 of the entry 312(1) to a value 512 of zero (0).

Referring now to FIG. 5C, the early execution engine 306 then provides the incoming instruction 500′ to the back-end instruction pipeline 304 as an outgoing instruction 514 for execution, as indicated by arrow 516. As noted above with respect to FIG. 4C, the outgoing instruction 514 provided to the back-end instruction pipeline 304 may be marked by the OOO processor 300 to indicate that its output is to be written back to the early register cache 310 of the early execution engine 306. Some aspects may provide that only the outgoing instruction 514 having the output operand 511 corresponding to an entry 312(0)-312(3) of the early register cache 310 is marked by the OOO processor 300.

In the example of FIG. 5C, after the incoming instruction 500′ is executed by the back-end instruction pipeline 304, the early execution engine 306 receives a resulting architectural register value 518 via a feedback path 520 from the OOO processor 300. The architectural register value 518 is stored in the entry 312(1) corresponding to the output operand 511 (i.e., register R1), and the valid flag field 318 of the entry 312(1) is set to a value 512′ of one (1), indicating that the entry 312(1) is now valid. Note that, as part of executing the incoming instruction 500′, the back-end instruction pipeline 304 also retrieves an architectural register value 522 for register R2, which corresponds to the input operand 504 of the incoming instruction 500 of FIG. 5A. Thus, the early execution engine 306 also may receive the architectural register value 522 via a feedback path 524 from the OOO processor 300. The architectural register value 522 is stored in the entry 312(2) corresponding to the input operand 504 (i.e. register R2), and the valid flag field 318 of the entry 312(2) is set to a value 526 of one (1), indicating that the entry 312(2) is now valid.

In performing out-of-order processing, the OOO processor 300 may frequently execute instructions speculatively based on, e.g., predictions for how a conditional branch instruction (not shown) will resolve. The actual path taken by the conditional branch instruction may not be known until the conditional branch instruction is executed within the back-end instruction pipeline 304. The OOO processor 300 thus includes a mechanism to flush instructions that were incorrectly fetched based on a mispredicted branch instruction from the front-end instruction pipeline 302 and/or the back-end instruction pipeline 304.

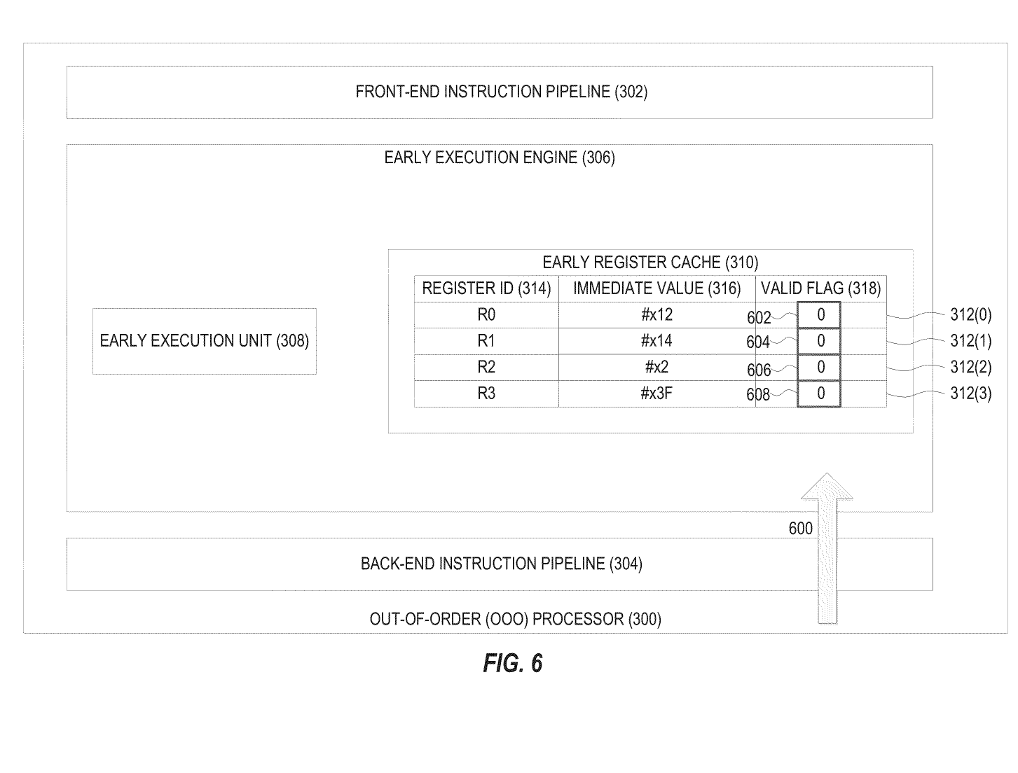

In the case of a pipeline flush, the early execution engine 306 in some aspects must update the contents of the early register cache 310 to invalidate any speculatively generated immediate values. In this regard, FIG. 6 illustrates exemplary communications flows for the early execution engine 306 of FIGS. 3A-3C for detecting and recovering from a pipeline flush. In FIG. 6, the early execution engine 306 receives an indication 600 of a pipeline flush from the OOO processor 300. In response, the early execution engine 306 may carry out any of a number of recovery mechanisms provided by the OOO processor 300 to recover from the misprediction that caused the pipeline flush. In some aspects, the early execution engine 306 may simply invalidate all of the entries 312(0)-312(3). This is illustrated in FIG. 6, where zero values 602, 604, 606, and 608 are written to the valid flag field 318 of the entries 312(0), 312(1), 312(2), and 312(3), respectively. In some aspects, the early execution engine 306 may selectively invalidate the entries 312(0)-312(3) based on register map table entries that are restored by the OOO processor 300. Some aspects may take a more aggressive approach by undoing updates to the early register cache 310 as the register map table 136 of FIG. 1 is recovered by the OOO processor 300.

To maximize performance benefits provided by the early execution engine 306, some aspects of the early execution engine 306 may seek to minimize the impact of pipeline flushes and/or instructions that are not eligible for processing by the early execution engine 306. A number of strategies may be employed by the early execution engine 306 and/or the OOO processor 300 based on the specific architecture provided by the OOO processor 300. For example, some aspects of the early execution engine 306 may be implemented on microarchitectures that provide the register access stage 122 of FIG. 1 prior to the insertion of instructions into the reservation stage 124. In such aspects, immediate values may be received by the early execution engine 306 and inserted directly into the early register cache 310 at register read time.

In some aspects, circumstances may arise in which the OOO processor 300 is not currently processing instructions (i.e., due to a pipeline stall in the front-end instruction pipeline 302, or after processing a pipeline flush). In such circumstances, it may be known by the OOO processor 300 that the contents of the register file 130 of FIG. 1 are up-to-date with no pending register write. Consequently, the early execution engine 306 may reload the contents of the early register cache 310 via a simple copy operation.

According to some aspects, the early execution engine 306 may track pending writes to architectural registers to determine when an immediate value may be safely copied from the register file 130 of FIG. 1 to the early register cache 310. For example, the early execution engine 306 may maintain a counter (not shown) per architectural register indicating a number of outstanding writes to each architectural register. The counter may be initialized to zero, and incremented when an incoming instruction that writes to the architectural register is observed by the early execution engine 306. The counter may also be decremented by the early execution engine 306 when the instruction is committed by the back-end instruction pipeline 304. When the counter value transitions from one (1) to zero (0), there are no pending writes to the architectural register, and thus the early execution engine 306 may safely copy the immediate value from the architectural register to the early register cache 310.

In some aspects, multiple versions of an incoming instruction may be in-flight at the same time. To track which version of an architectural register should provide its contents for an update to the early register cache 310, the early execution engine 306 may employ a tag (not shown) assigned to each in-flight instruction by the OOO processor 300. The tag may indicate to the early execution engine 306 the version of an architectural register update that should be used to update the early register cache 310.

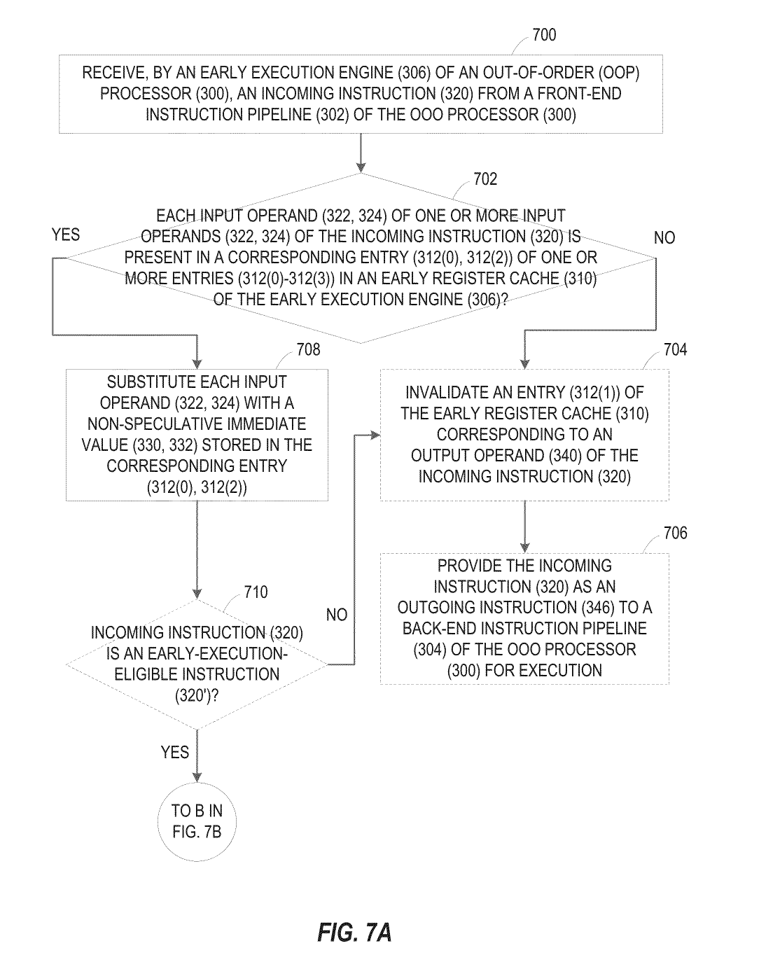

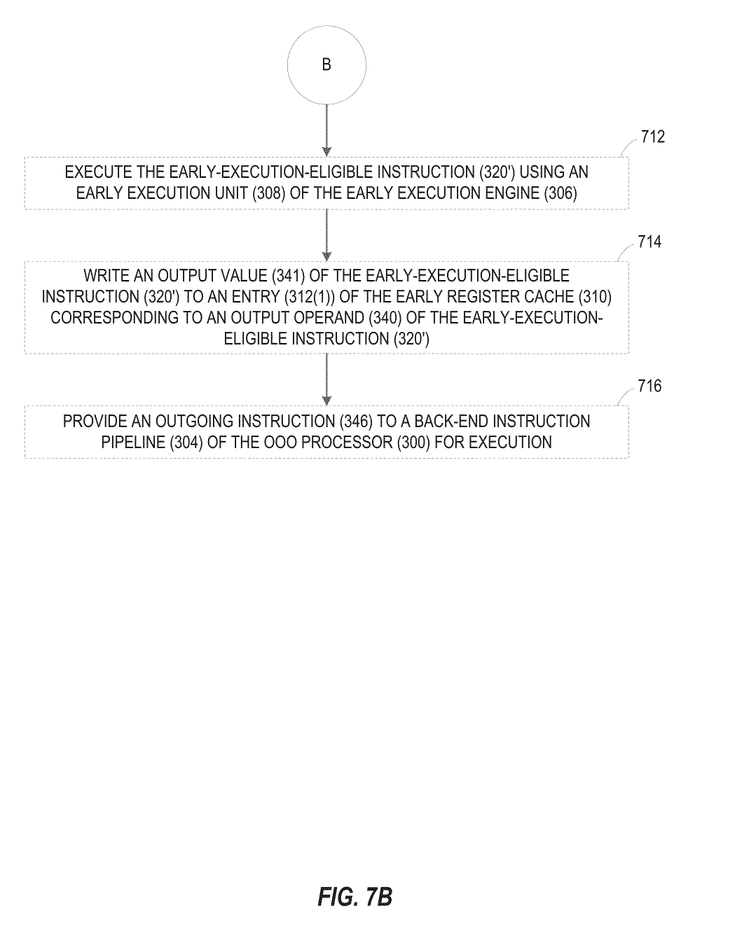

To illustrate an exemplary process for providing early instruction execution by the early execution engine 306 of FIGS. 3A-3C, FIGS. 7A and 7B are provided. FIG. 7A illustrates exemplary operations for determining whether input operands for an incoming instruction are cached by the early execution engine 306, and detecting early-execution-eligible instructions. FIG. 7B illustrates exemplary operations for carrying out early execution of an early-execution-eligible instruction. For the sake of clarity, elements of FIG. 1 and FIGS. 3A-3C are referenced in describing FIGS. 7A and 7B.

Operations begin in FIG. 7A with the early execution engine 306 of the OOO processor 300 receiving the incoming instruction 320 from the front-end instruction pipeline 302 of the OOO processor 300 (block 700). The early execution engine 306 next determines whether an input operand 322 or 324 of one or more input operands 322, 324 of the incoming instruction 320 is present in a corresponding entry 312(0), 312(2) of one or more entries 312(0)-312(3) in the early register cache 310 of the early execution engine 306 (block 702). If the early execution engine 306 determines that one or more of the input operands 322, 324 is not present in the early register cache 310, the early execution engine 306 may invalidate an entry 312(1) of the early register cache 310 corresponding to an output operand 340 of the incoming instruction 320 (block 704). The early execution engine 306 may then provide the incoming instruction 320 as an outgoing instruction 346 to the back-end instruction pipeline 304 of the OOO processor 300 for execution (block 706).

However, if the early execution engine 306 determines at decision block 702 that each of the input operands 322, 324 is present in the early register cache 310, the early execution engine 306 substitutes the input operand 322 or 324 with a non-speculative immediate value 330, 332 stored in the corresponding entry 312(0), 312(2) (block 708). In this manner, the incoming instruction 320 may be executed without requiring a register access to retrieve its input operands 322, 324.

In some aspects, the early execution engine 306 next determines whether the incoming instruction 320 is an early-execution-eligible instruction 320′ (block 710). The early-execution-eligible instruction 320′, in some aspects, may be a relatively simple arithmetic, logic, or shift operation that is supported by the early execution unit 308. Some aspects may provide that the early-execution-eligible instruction 320′ is marked during decoding by the OOO processor 300 for detection by the early execution engine 306.

If the early execution engine 306 determines at decision block 710 that the incoming instruction 320 is not the early-execution-eligible instruction 320′, processing may resume at block 704 for handling the incoming instruction 320 in a similar manner as if one or more of the input operands 322, 324 of the incoming instruction 320 were not cached in the early register cache 310. However, if the incoming instruction 320 is the early-execution-eligible instruction 320′, processing resumes at block 712 of FIG. 7B.

Referring now to FIG. 7B, the early execution unit 308 of the early execution engine 306 may execute the early-execution-eligible instruction 320′ (block 712). After execution, the early execution unit 308 may write an output value 341 of the early-execution-eligible instruction 320′ to an entry 312(1) of the early register cache 310 corresponding to an output operand 340 of the early-execution-eligible instruction 320′ (block 714). In this manner, the result of executing the early-execution-eligible instruction 320′ may be made immediately available to subsequent instructions.

Following the early execution of the early-execution-eligible instruction 320′, the early execution engine 306 may provide an outgoing instruction 346 to the back-end instruction pipeline 304 of the OOO processor 300 for execution (block 716). In some aspects, the outgoing instruction 346 may reproduce a result (e.g., a write to a register) as if the early-execution-eligible instruction 320′ were executed in the back-end instruction pipeline 304. In this manner, the actual contents of the registers 132(0)-132(X) may remain consistent with the contents of the early register cache 310.

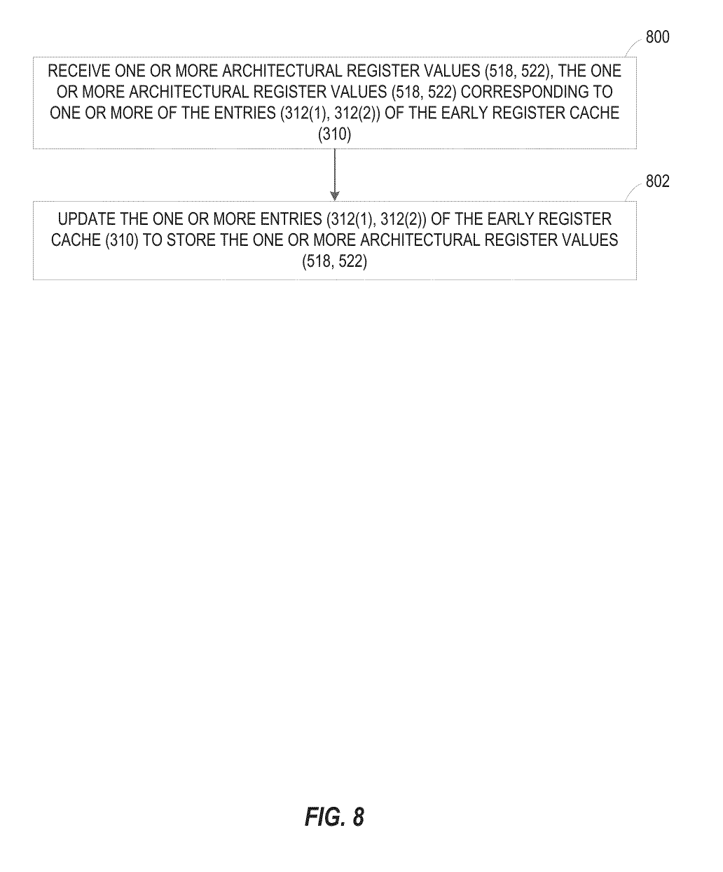

FIG. 8 illustrates additional exemplary operations for updating the early register cache 138 of FIG. 1 based on received architectural register values. For example, the architectural register values may be received by the early register cache 138 following execution of an instruction by the back-end instruction pipeline 114 in some aspects. In describing FIG. 8, elements of FIGS. 5A-5C are referenced for the sake of clarity.

In FIG. 8, operations begin with the early execution engine 306 receiving one or more architectural register values 518, 522, the one or more architectural register values 518, 522 corresponding to one or more of the entries 312(1), 312(2) of the early register cache 310 (block 800). In some aspects, the one or more architectural register values 518, 522 may represent the result of a non-early-execution-eligible instruction executed by the back-end instruction pipeline 304 received by the early execution engine 306. Some aspects may provide that the one or more architectural register values 518, 522 may represent a result of fetching an input operand 504 from a register 132(0)-132(X). According to some aspects, the one or more architectural register values 518, 522 may be received via a feedback path 520, 524 from the OOO processor 300. Upon receiving the one or more architectural register values 518, 522, the early execution engine 306 may then update the one or more entries 312(1), 312(2) of the early register cache 310 to store the one or more architectural register values 518, 522 (block 802).

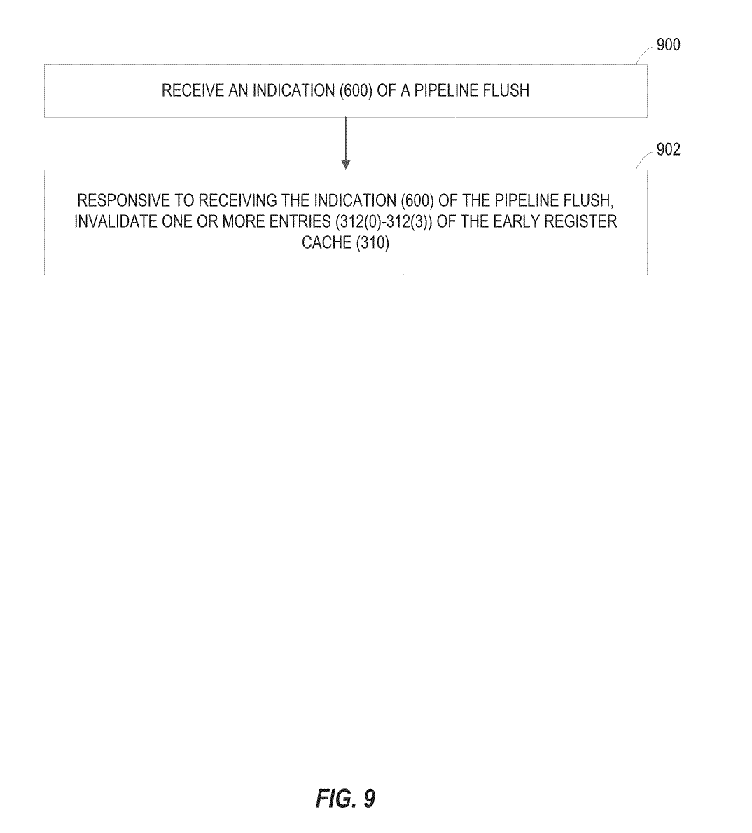

To illustrate additional exemplary operations for detecting and recovering from a pipeline flush according to some aspects of the early execution engine 102 of FIG. 1, FIG. 9 is provided. For the sake of clarity, elements of FIG. 6 are referenced in describing FIG. 9. In FIG. 9, operations begin with the early execution engine 306 receiving an indication 600 of a pipeline flush (block 900). In some aspects, the indication 600 may be received from the OOO processor 300 in response to an occurrence such as a mispredicted branch detected in the back-end instruction pipeline 304. Responsive to receiving the indication 600 of the pipeline flush, the early execution engine 306 invalidates one or more entries 312(0)-312(3) of the early register cache 310 (block 902). In some aspects, all entries 312(0)-312(3) of the early register cache 310 may be invalidated, while some aspects may provide that the entries 312(0)-312(3) are selectively invalidated.

Providing early instruction execution in an OOO processor according to aspects disclosed herein may be provided in or integrated into any processor-based device. Examples, without limitation, include a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

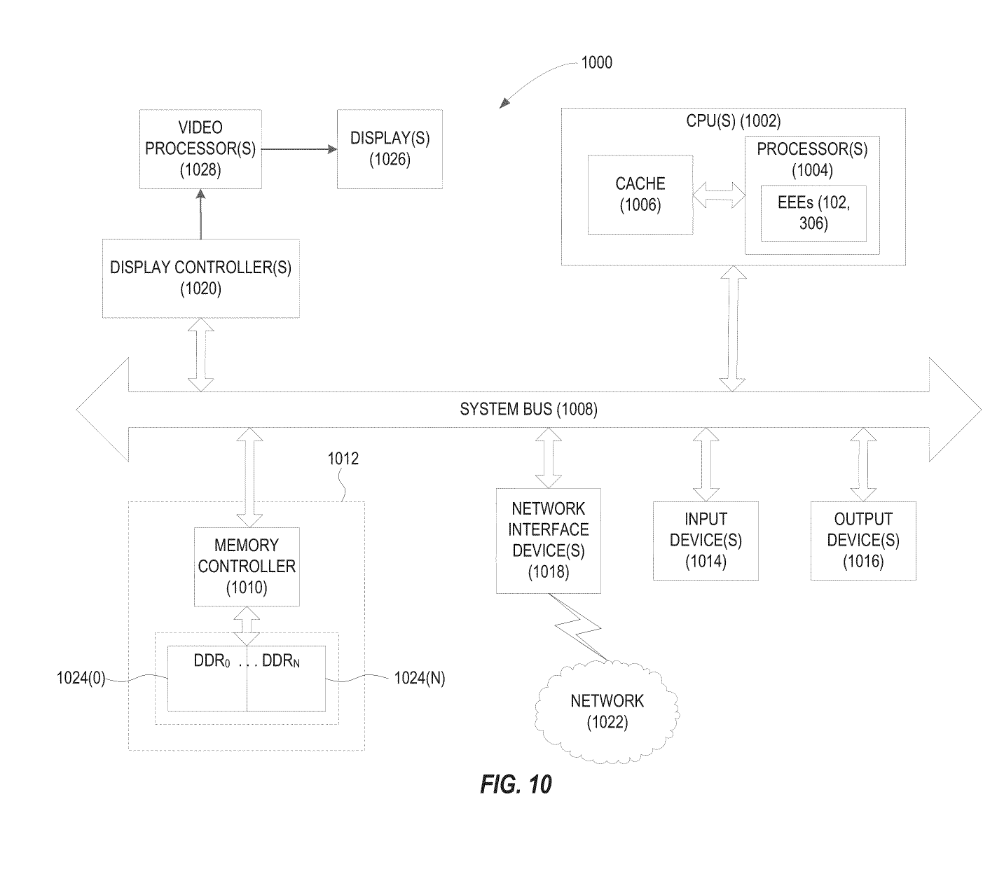

In this regard, FIG. 10 illustrates an example of a processor-based system 1000 that can employ the early execution engines 102, 306 of FIGS. 1 and 3A-3C. In this example, the processor-based system 1000 includes one or more central processing units (CPUs) 1002, each including one or more processors 1004. The one or more processors 1004 may include the early execution engines (EEEs) 102, 306 of FIGS. 1 and 3A-3C. The CPU(s) 1002 may be a master device. The CPU(s) 1002 may have cache memory 1006 coupled to the processor(s) 1004 for rapid access to temporarily stored data. The CPU(s) 1002 is coupled to a system bus 1008 and can intercouple master and slave devices included in the processor-based system 1000. As is well known, the CPU(s) 1002 communicates with these other devices by exchanging address, control, and data information over the system bus 1008. For example, the CPU(s) 1002 can communicate bus transaction requests to a memory controller 1010 as an example of a slave device.

Other master and slave devices can be connected to the system bus 1008. As illustrated in FIG. 10, these devices can include a memory system 1012, one or more input devices 1014, one or more output devices 1016, one or more network interface devices 1018, and one or more display controllers 1020, as examples. The input device(s) 1014 can include any type of input device, including but not limited to input keys, switches, voice processors, etc. The output device(s) 1016 can include any type of output device, including but not limited to audio, video, other visual indicators, etc. The network interface device(s) 1018 can be any devices configured to allow exchange of data to and from a network 1022. The network 1022 can be any type of network, including but not limited to a wired or wireless network, a private or public network, a local area network (LAN), a wide local area network (WLAN), and the Internet. The network interface device(s) 1018 can be configured to support any type of communications protocol desired. The memory system 1012 can include the memory controller 1010 and one or more memory units 1024(0-N).

The CPU(s) 1002 may also be configured to access the display controller(s) 1020 over the system bus 1008 to control information sent to one or more displays 1026. The display controller(s) 1020 sends information to the display(s) 1026 to be displayed via one or more video processors 1028, which process the information to be displayed into a format suitable for the display(s) 1026. The display(s) 1026 can include any type of display, including but not limited to a cathode ray tube (CRT), a liquid crystal display (LCD), a plasma display, etc.

Those of skill in the art will further appreciate that the various illustrative logical blocks, modules, circuits, and algorithms described in connection with the aspects disclosed herein may be implemented as electronic hardware, instructions stored in memory or in another computer-readable medium and executed by a processor or other processing device, or combinations of both. The master and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flow chart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. An apparatus comprising an early execution engine,
the early execution engine communicatively coupled to a front-end instruction pipeline and a back-end instruction pipeline of an out-of-order (OOO) processor;
the early execution engine comprising:
an early execution unit; and
an early register cache; and
the early execution engine configured to:
receive an incoming instruction from the front-end instruction pipeline;
determine whether an input operand of one or more input operands of the incoming instruction is present in a corresponding entry of one or more entries in the early register cache; and
responsive to determining that the input operand is present in the corresponding entry, substitute the input operand with a non-speculative immediate value stored in the corresponding entry.

2. The apparatus of claim 1, wherein the early execution engine is further configured to, responsive to determining that the input operand is not present in the corresponding entry:
invalidate an entry of the early register cache corresponding to an output operand of the incoming instruction; and
provide the incoming instruction as an outgoing instruction to the back-end instruction pipeline for execution.

3. The apparatus of claim 1, wherein the early execution engine is further configured to:
determine whether the incoming instruction is an early-execution-eligible instruction; and
responsive to determining that the incoming instruction is the early-execution-eligible instruction:
execute the early-execution-eligible instruction using the early execution unit of the early execution engine;
write an output value of the early-execution-eligible instruction to an entry of the early register cache corresponding to an output operand of the early-execution-eligible instruction; and
provide an outgoing instruction to the back-end instruction pipeline for execution.

4. The apparatus of claim 3, wherein the early execution engine is further configured to, responsive to determining that the incoming instruction is not the early-execution-eligible instruction:
invalidate the entry of the early register cache corresponding to the output operand of the incoming instruction; and
provide the incoming instruction as the outgoing instruction to the back-end instruction pipeline for execution.

5. The apparatus of claim 1, wherein the early execution engine is further configured to:
receive one or more architectural register values from the OOO processor, the one or more architectural register values corresponding to the one or more entries in the early register cache; and
update the one or more entries of the early register cache to store the one or more architectural register values.

6. The apparatus of claim 1, wherein the early execution engine is further configured to:
receive an indication of a pipeline flush; and
responsive to receiving the indication of the pipeline flush, invalidate one or more of the one or more entries of the early register cache.

7. The apparatus of claim 1, wherein at least one entry of the one or more entries of the early register cache is configured to store a narrow-width operand.

8. The apparatus of claim 1, wherein the one or more entries of the early register cache corresponds to a subset of a plurality of architectural registers of the OOO processor.

9. The apparatus of claim 1 integrated into an integrated circuit (IC).

10. The apparatus of claim 1 integrated into a device selected from the group consisting of: a set top box; an entertainment unit; a navigation device; a communications device; a fixed location data unit; a mobile location data unit; a mobile phone; a cellular phone; a computer; a portable computer; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; and a portable digital video player.

11. An apparatus comprising an early execution engine of an out-of-order (OOO) processor, the early execution engine comprising:
a means for receiving an incoming instruction from a front-end instruction pipeline of the OOO processor;
a means for determining whether an input operand of one or more input operands of the incoming instruction is present in a corresponding entry of one or more entries in an early register cache of the early execution engine; and
a means for substituting the input operand with a non-speculative immediate value stored in the corresponding entry, responsive to determining that the input operand is present in the corresponding entry.

12. A method for providing early instruction execution, comprising:
receiving, by an early execution engine of an out-of-order (OOO) processor, an incoming instruction from a front-end instruction pipeline of the OOO processor;
determining whether an input operand of one or more input operands of the incoming instruction is present in a corresponding entry of one or more entries in an early register cache of the early execution engine; and
responsive to determining that the input operand is present in the corresponding entry, substituting the input operand with a non-speculative immediate value stored in the corresponding entry.

13. The method of claim 12, further comprising, responsive to determining that the input operand is not present in the corresponding entry:
invalidating an entry of the early register cache corresponding to an output operand of the incoming instruction; and
providing the incoming instruction as an outgoing instruction to a back-end instruction pipeline of the OOO processor for execution.

14. The method of claim 12, further comprising:
determining whether the incoming instruction is an early-execution-eligible instruction; and
responsive to determining that the incoming instruction is the early-execution-eligible instruction:
executing the early-execution-eligible instruction using an early execution unit of the early execution engine;
writing an output value of the early-execution-eligible instruction to an entry of the early register cache corresponding to an output operand of the early-execution-eligible instruction; and
providing an outgoing instruction to a back-end instruction pipeline of the OOO processor for execution.

15. The method of claim 14, further comprising, responsive to determining that the incoming instruction is not the early-execution-eligible instruction:
invalidating the entry of the early register cache corresponding to the output operand of the incoming instruction; and
providing the incoming instruction as the outgoing instruction to the back-end instruction pipeline for execution.

16. The method of claim 12, further comprising:
receiving one or more architectural register values from the OOO processor, the one or more architectural register values corresponding to the one or more entries of the early register cache; and
updating the one or more entries of the early register cache to store the one or more architectural register values.

17. The method of claim 12, further comprising:
receiving an indication of a pipeline flush; and
responsive to receiving the indication of the pipeline flush, invalidating one or more of the one or more entries of the early register cache.

18. The method of claim 12, wherein at least one entry of the one or more entries of the early register cache is configured to store a narrow-width operand.

19. The method of claim 12, wherein the one or more entries of the early register cache corresponds to a subset of a plurality of architectural registers of the OOO processor.

20. A non-transitory computer-readable medium having stored thereon computer-executable instructions which, when executed by a processor, cause the processor to:
receive an incoming instruction from a front-end instruction pipeline of the processor;
determine whether an input operand of one or more input operands of the incoming instruction is present in a corresponding entry of one or more entries in an early register cache of an early execution engine; and
responsive to determining that the input operand is present in the corresponding entry, substitute the input operand with a non-speculative immediate value stored in the corresponding entry.

21. The non-transitory computer-readable medium of claim 20 having stored thereon computer-executable instructions which, when executed by a processor, further cause the processor to, responsive to determining that the input operand is not present in the corresponding entry:
invalidate an entry of the early register cache corresponding to an output operand of the incoming instruction; and
provide the incoming instruction as an outgoing instruction to a back-end instruction pipeline of the processor for execution.

22. The non-transitory computer-readable medium of claim 20 having stored thereon computer-executable instructions which, when executed by a processor, further cause the processor to:
determine whether the incoming instruction is an early-execution-eligible instruction; and
responsive to determining that the incoming instruction is the early-execution-eligible instruction:
execute the early-execution-eligible instruction using an early execution unit of the early execution engine;
write an output value of the early-execution-eligible instruction to an entry of the early register cache corresponding to an output operand of the early-execution-eligible instruction; and
provide an outgoing instruction to a back-end instruction pipeline of the processor for execution.

23. The non-transitory computer-readable medium of claim 22 having stored thereon computer-executable instructions which, when executed by a processor, further cause the processor to, responsive to determining that the incoming instruction is not the early-execution-eligible instruction:
invalidate the entry of the early register cache corresponding to the output operand of the incoming instruction; and
provide the incoming instruction as the outgoing instruction to the back-end instruction pipeline for execution.

23. The non-transitory computer-readable medium of claim 20 having stored thereon computer-executable instructions which, when executed by a processor, further cause the processor to:
receive one or more architectural register values, the one or more architectural register values corresponding to the one or more entries of the early register cache; and
update the one or more entries of the early register cache to store the one or more architectural register values.

24. The non-transitory computer-readable medium of claim 20 having stored thereon computer-executable instructions which, when executed by a processor, further cause the processor to:
receive an indication of a pipeline flush; and
responsive to receiving the indication of the pipeline flush, invalidate one or more of the one or more entries of the early register cache.

25. The non-transitory computer-readable medium of claim 20 having stored thereon computer-executable instructions which, when executed by a processor, further cause the processor to store a narrow-width operand in at least one entry of the one or more entries of the early register cache.

26. The non-transitory computer-readable medium of claim 20 having stored thereon computer-executable instructions which, when executed by a processor, further cause the processor to associate the one or more entries of the early register cache with a subset of a plurality of architectural registers of the processor.
